(19) United States
(12) Patent Application Publication
(10) Pub. No.: US 2016/0019485 A1
(43) Pub. Date: Jan. 21, 2016

(54) METHOD AND SYSTEM FOR SCHEDULING MEETINGS

(71) Applicant: Wipro Limited, Bangalore (IN)

(72) Inventors: Raghavendra Hosabettu, Bangalore (IN); Parthasarathy Armugasamy, Bangalore (IN); Kiran Kumar Channarayapatna Sathyanarayana, Bangalore (IN)

(21) Appl. No.: 14/476,795

(22) Filed: Sep. 4, 2014

(30) Foreign Application Priority Data
Jul. 16, 2014 (IN) 3492/CHE/2014

(51) Int. Cl. G06Q 10/06

(52) U.S. Cl. CPC G06Q 10/06314

(57) ABSTRACT

The present subject matter relates to a method, system, and non-transitory computer readable medium for scheduling meetings. In an embodiment, the method comprises receiving, by a meeting organizer system, meeting data and information about a plurality of registered participants. Then, a unified view of one or more profiles of each of the registered participants is generated based on one or more predefined rules. Further, a confidence score is determined for predicting success of the meeting organization based on at least one of the meeting data and historical data of each of the registered participant. Then, meeting schedule is modified based on the confidence score. Finally, a meeting invitation to a participant device associated to each of the registered participants based on the confidence score.

This application claims the benefit of U.S. Foreign Patent Application Serial No. 3492/CHE/2014 filed Jul. 16, 2014, which is hereby incorporated by reference in its entirety.

### FIELD

The present subject matter is related, in general to scheduling meetings, and more particularly, but not exclusively to a method and a system for scheduling meetings.

### BACKGROUND

At present, calendar systems provide tools to find time for organizing a meeting. The tools look at available time and resources, finds the open space that most closely matches the time. Then, the tool schedules the time and notifies the attendees.

Generally, organizing cross company meetings when participants may not have common email, messaging service or applications is a challenge. In several cases, participant for a meeting can have multiple profiles like profile of company employed with, profile of company working for, personal profile etc. While organizing cross-company meeting, organizations would like to restrict information exchange based on their policy, for example calendar information, employee profiles etc. to the external systems. In such a case, a meeting organizer may not have visibility of entire calendar information and availability of all potential participants. Also, each organization can have different vocabulary for their industry, employee roles and functions, making the job of meeting scheduler more complicated. In heterogeneous distributed systems involving multiple organizations, interoperability issue is one of the major concerns for organizing a meeting for people having different profiles, roles etc. This gets further complicated while dealing with varied systems like Microsoft exchange, IBM Lotus and Google Calendar. The lack of interoperability leads to challenges in organizing a cross organizational meeting in terms of knowing available time-slots, location and availability status for participants. Also, since multiple organizations are involved in the meeting, identification of commonly understood roles of participants for type of meetings is required.

In case a person, i.e. potential invitee has multiple profiles for company employed with, company working for, personal etc. The person may want to use same meeting organization application for all the meetings involving all of these profiles. However, current meeting organization applications do not support multiple profiles of a person during organization of meetings. Also, the present meeting organization applications do not provide a unified view of all active meetings for a participant involving different profiles at any moment.

The meeting organizer application should allow participants to accept meeting requests and view status of all of their meetings at any point of time on their devices. However, presently, user using different applications, devices, channels at different point of time or due to different other factors like location, mobility etc., are unable to dynamically view and perform required action on the meeting request, status-change, acceptance etc.

Further, in the present scheduling systems, the user is not provided with mechanism to change the mode of communication for joining the meeting depending on location, access and other factors of potential participants. Further, when a meeting is no longer valid due to insufficient acceptance from participants, it is desirable to inform the participants about the change in meeting status on time, in order to avoid wasting their valuable time.

In a cross organizational meeting scenario, the success of scheduling and conducting a meeting depends greatly on the availability and attendance of each participant/invitee. In such a situation, it is essential to know the availability of time-slots of key participants and possibility of attendance of a key participant for the meeting. Presently, there is no mechanism available for such prediction.

Therefore, there is a need for a method and a system to perform aggregation of unified profile view for each participant to identify suitable participants for a meeting being scheduled and also obtain information about availability of identified participants. Further, there is a need for a method to predict the possibility of attendance of key participants for a successful occurrence of the meeting being scheduled.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Disclosed herein is a method for scheduling meetings. The method comprises receiving, by a meeting organizer system, meeting data and information about a plurality of registered participants. Then, the method comprises generating a unified view of one or more profiles of each of the registered participant based on one or more predefined rules. Further, the method determines a confidence score for predicting success of the meeting organization based on at least one of the meeting data and historical data of each of the registered participant. Then, the method modifies meeting schedule based on the confidence score and transmits meeting invitation to a participant device associated to each of the registered participants based on the confidence score.

In an aspect of the present disclosure, a meeting organizer system for scheduling meeting is provided. The meeting organizer system comprises a processor, and a memory communicatively coupled to the processor. The memory is configured to store processor-executable instructions, which, on execution, causes the processor to receive meeting data and information about a plurality of registered participants. The processor then generates a unified view of one or more profiles of each of the registered participants based on one or more predefined rules. Further, the processor determines a confidence score for predicting success of the meeting organization based on at least one of the meeting data and historical data of each of the registered participant. The processor modifies meeting schedule based the confidence score and transmits meeting invitation to a participant device associated to each of the registered participants based on the confidence score.

In another aspect of the present disclosure, a non-transitory computer readable medium including instructions stored thereon is provided. The instructions when processed by at least one processor cause a meeting organizer system to perform the acts of generating a unified view of one or more profiles of each of the registered participants based on one or more predefined rules,

determining a confidence score for predicting success of the meeting organization based on at least one of the meeting data and historical data of each of the registered participant, modifying meeting schedule based on the confidence score and transmitting meeting invitation to a participant device associated to each of the registered participants based on the confidence score.

The foregoing summary is illustrative only and is not intended to be in any way limiting. In addition to the illustrative aspects, embodiments and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates architecture of system for scheduling meetings between plurality of participants having multiple profiles in accordance with some embodiments of the present disclosure;

FIG. 2 illustrates a block diagram of meeting organizer system for scheduling meetings in accordance with some embodiments of the present disclosure;

FIG. 3 illustrates a flowchart of method for registration and profile creation of a participant in accordance with some embodiments of the present disclosure;

FIG. 4 illustrates a flowchart of method for scheduling meetings between plurality of participants having multiple profiles in accordance with some embodiments of the present disclosure;

FIG. 5 illustrates a flow diagram for providing a unified view of multiple profiles of a participant in accordance with some embodiments of the present disclosure; and

FIG. 6 illustrates a flow diagram for determining a meeting confidence score in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to apparatuses, methods, and non-transitory computer readable media for novel approaches for scheduling meetings, which have not been considered before. In one example, the methods for scheduling meetings are implemented using a meeting organizer computing device configured to execute programmed instructions for the technology as illustrated and described with the technology herein. With this technology, the functioning of the meeting organizer computing device along with other types and/or numbers of other servers, participant computing devices, and/or databases in scheduling meetings is improved. The method provides for scheduling of meeting in a scenario where multiple profiles of each participant are involved. In an embodiment, the meeting organizer is provided with a unified view of multiple profiles of each participant. In this way, the meeting organizer has a complete view of availability of the participants. The method for meeting scheduling also determines a confidence score for predicting success of the meeting organization. The confidence score is calculated based on at least one of the meeting data and historical data of each of the participant.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

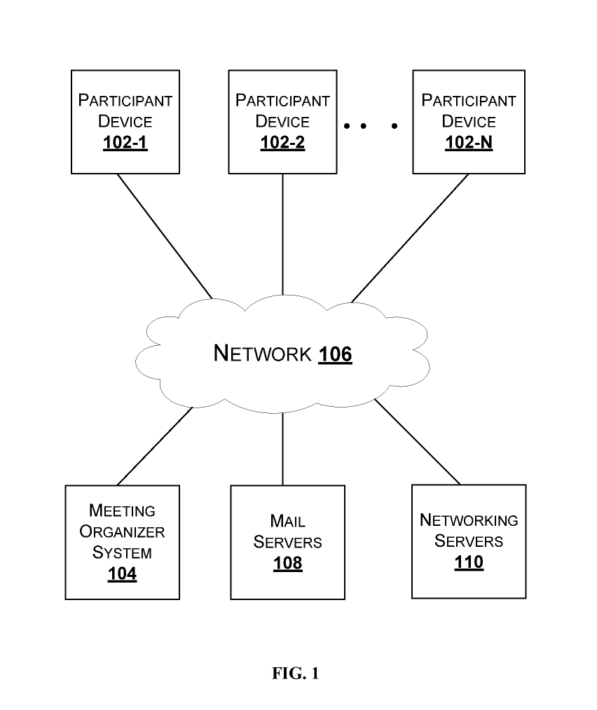

FIG. 1 illustrates architecture of system for scheduling meetings between plurality of participants having multiple profiles in accordance with some embodiments of the present disclosure.

As shown in FIG. 1, a system 100 for scheduling meetings between a plurality of participants having multiple profiles comprises one or more components coupled with each other. In one implementation, the system 100 comprises one or more client devices 102-1, 102-2, . . . 102-N (collectively referred to as client devices 102). Examples of the client devices 102 include, but are not limited to, a desktop computer, a portable computer, a mobile phone, a handheld device, a workstation. The client devices 102 may be used by various stakeholders or end users of the organization, such as project managers, executives and employees. As shown in the FIG. 1, such client devices 102 are communicatively coupled to a meeting organizer system 104 through a network 106 for facilitating scheduling of the meetings. The meeting organizer system 104 is further connected through the network 106 to one or more mail servers 108 and one or more networking servers 110.

The network 106 may be a wireless network, wired network or a combination thereof. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106 may include a variety of network devices, including routers, bridges, servers, computing devices, storage devices, etc.

The client devices 102 comprise an application program that uses the services of the meeting organizer system 104. The client devices 102 with the application program may be implemented in a variety of computing systems, such as a laptop computer, a desktop computer, a notebook, a workstation, a mainframe computer, a server, a network server, and the like.

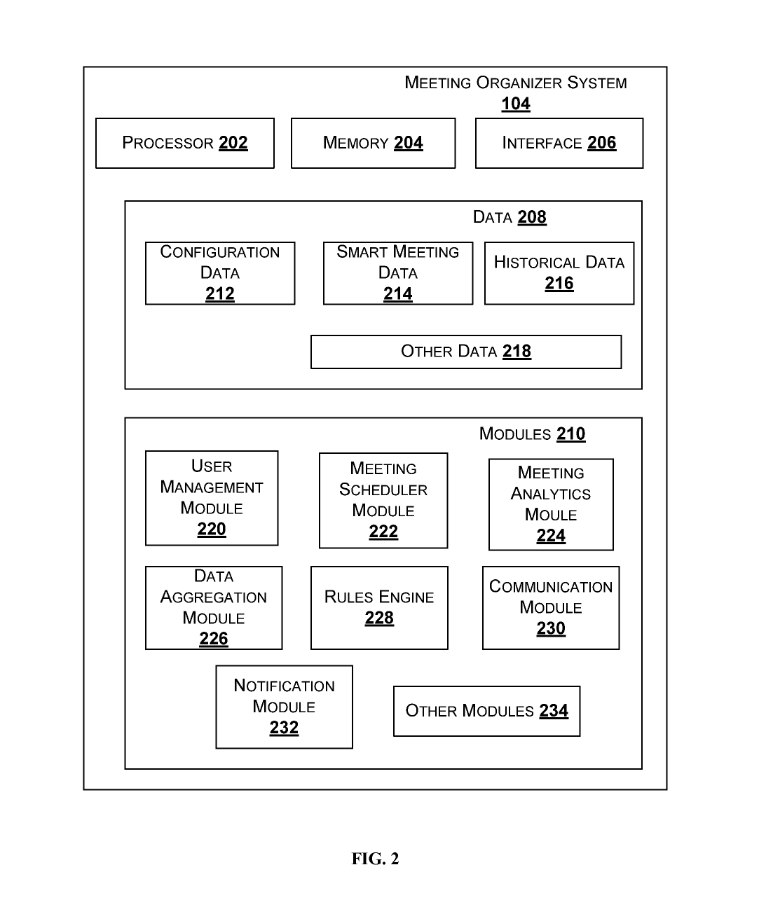

In one implementation, the meeting organizer system 104, as shown in FIG. 2, includes a central processing unit (“CPU” or “processor”) 202, a memory 204 and an Interface 206. Processor 202 may comprise at least one data processor for executing program components and for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc. Among other capabilities, the processor 202 is configured to fetch and execute computer-readable instructions stored in the memory 204. The memory 204 can include any non-transitory computer-readable medium known in the art including, for example, volatile memory (e.g., RAM), and/or non-volatile memory (e.g., EPROM, flash memory, etc.).

The interface(s) 206 may include a variety of software and hardware interfaces, for example, a web interface, a graphical user interface, etc. The interface 206 is coupled with the processor 202 and an I/O device. The I/O device is configured to receive inputs from user via the interface 206 and transmit outputs for displaying in the I/O device via the interface 206.

In one implementation, the meeting organizer system 104 further comprises data 208 and modules 210. In one example, the data 208 and the modules 210 may be stored within the memory 204. In one example, the modules 210, amongst other things, include routines, programs, objects, components, and data structures, which perform particular tasks or implement particular abstract data types. The modules 210 may also be implemented as, signal processor(s), state machine(s), logic circuitries, and/or any other device or component that manipulate signals based on operational instructions. Further, the modules 210 can be implemented by one or more hardware components, by computer-readable instructions executed by a processing unit, or by a combination thereof.

In one implementation, the data 208 may include, for example, configuration data 212, smart meeting data 214, historical data 216, and other data 218. In one embodiment, the data 208 may be stored in the memory 204 in the form of various data structures. Additionally, the aforementioned data can be organized using data models, such as relational or hierarchical data models. The other data 224 may be used to store data, including temporary data and temporary files, generated by the modules 210 for performing the various functions of the meeting organizer system 104.

The modules 210 may include, for example, a user management module 220, a meeting scheduler module 222, a meeting analytics module 224, a data aggregator 226, a rules engine 228, a communication module 230 and a notification module 232 coupled with the processor 202. The meeting organizer system 104 may also comprise other modules 234 to perform various miscellaneous functionalities of the meeting organizer system 104. It will be appreciated that such aforementioned modules may be represented as a single module or a combination of different modules.

In operation, the user management module 220 is configured to manage individual users. The user may include, meeting organizer, administrator, participants of meeting or any other user. The management of users comprises managing user profiles, skills of the user, privileges of the user based on roles, and privacy rules of the users. In addition, the user management module 220 performs registration of the users to the system.

In an embodiment, the meeting scheduler module 222 performs automatic scheduling of meetings. The meeting scheduler module 222 detects conflicts between different meeting schedules. Also, the meeting scheduler module 222 provides possible solutions for resolving the conflicts.

The meeting analytics module 224 takes data as input and analyzes the data to predict availability of each participant for a scheduled meeting. For example, the meeting analytics module 224 performs prediction based on past participation details of each participant.

In an embodiment, the data aggregator 226 collects profile of the participants. The profile includes personal and official calendar details of the participant. The data aggregator 226 communicates with the one or more mail servers 108 or external system through network servers 110 to retrieve the calendar details. As an example, the mail servers 108 may include MS Exchange/calendar, or any other third party systems like Customer Relationship Management (CRM) system. Then, the data aggregator 226 stores the retrieved calendar details of each of the participant into the smart meeting data 214.

The rules engine 228 performs adding of meeting related rules and updating the meeting related rules. The rules are added and updated based on organization and participant criteria. The rules engine 228 stores the rules in the smart meeting data 214.

In an embodiment, the communication module 230 provides user preferences and organization preferences of communication channel for a meeting. As an example, the communication module 230 provides the channel preference based on profile of the participants, time of the meeting, type of the meeting and location of the meeting.

The notification module 232 connects to one or more mail servers 108, and one or more networking servers 110 which in turn connect to connect to one or more external systems. In one embodiment, the notification module 232 connects to the one or more external systems for sending and receiving e-mails. Also the notification module 232 extracts profile details of the participant from social media networking servers, enterprise systems etc. As an example, the networking servers may include Facebook, Twitter, and LinkedIn etc. These profile details are used for verification of the registered participants and as input for the unified profile view.

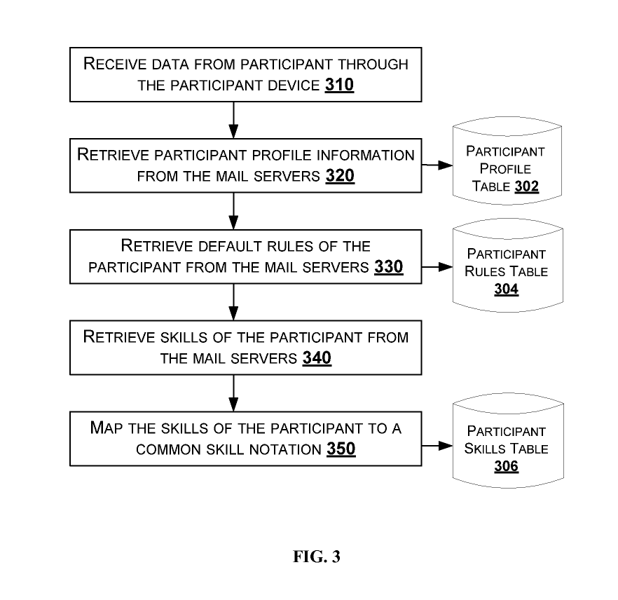

FIG. 3 illustrates a flowchart of method for registration and profile creation of a participant in accordance with some embodiments of the present disclosure.

As illustrated in FIG. 3, the method 300 comprises one or more blocks for registration and profile creation of a participant. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

Initially a participant is registered on the meeting scheduling application. After registration, a profile of the registered participant is created.

At block 310, participant inputs data through the associated participant device 102. In an embodiment, the participant enters data like e-mail id, password, and calendar system information.

At block 320, receive participant profile information from the mail servers 108 and external systems through the network servers 110. The data aggregation module 226 retrieves the profile information of the participant from one or more mail servers 108 like Gmail™, Yahoo™ mail, MS exchange etc. As an example, the profile information may include, e-mail id in multiple enterprise systems, preferred mode of communication of the participant like voice call, video call, in-person meeting etc., privacy rules like ‘Do not Disturb” time set by the participant, skills of the participant, roles of the participant based on competency, geographical location of the participant and current location of the participant. In one embodiment, the profile of the participant may be validated with information available on the one or more networking servers 110. As an example, the personal profile of the participant may be validated with information available on social networking websites like Facebook™, LinkedIn™ etc. Simultaneously, the profile information of the participant is stored in a participant profile table 302 of smart meeting data 214.

At block 330, default rules of the participant are retrieved from calendar or external system information provided by the participant. The calendar systems may include, for example, MS Exchange, Gmail, yahoo mail, and personal calendars. In an embodiment, the rules defined by company of the participant and personal rules are retrieved by the data aggregation module 226. The rules may include, but are not limited to, rules to check on participants who should not be participating in the meeting if there is a potential conflict of information disclosure. For example, if the participants are customers from different competitor company, then both of the participants should not attend the same meeting. Further, the rules may also include rules to check time zone of participants, time preferences of participants, communication mode etc. For example, few participants may prefer morning meeting, than evening meetings. Also, the rules may include rules to check common mode of communication among all the participants and rules for updating the profile of the participants. The updation can include, for example, deletion of record from profile of participant when the participant leaves an organization. Simultaneously, the rules of the participant are stored in a participant rules table 304 of smart meeting data 214.

At block 340, retrieve skills of the participant from the mail servers 108. In an embodiment, the data aggregation module 226 retrieves professional and personal skills of the participant from the one or more mail servers 108 and one or more networking servers 110. As an example, skills of the participant may include technological skills of the participant, roles handled by the participant like developer, tester, project manager, architect etc., and domain of experience of the participant like retail, insurance, construction, engineering etc.

Then, at block 350, the user management module 220 maps the retrieved skills to a common skill notation. Then, the data aggregation module 226 stores the common skill notations in a participant skills table 306 of the smart meeting data 214.

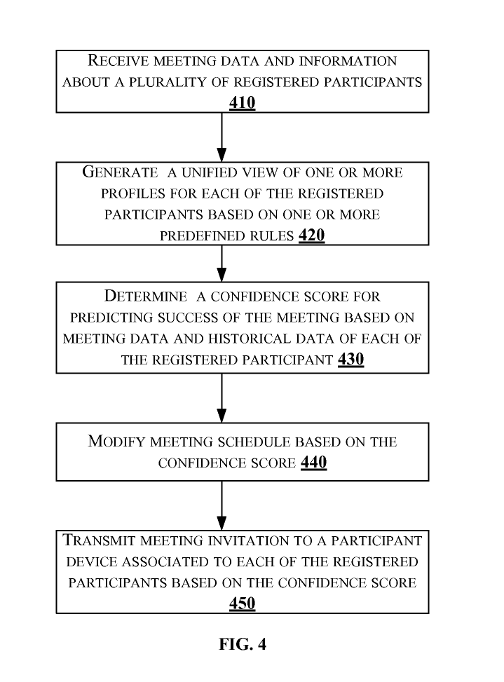

FIG. 4 illustrates a flowchart of method for scheduling meetings between plurality of participants having multiple profiles in accordance with some embodiments of the present disclosure.

The method 400 may be described in the general context of computer executable instructions. Generally, computer executable instructions can include routines, programs, objects, components, data structures, procedures, modules, and functions, which perform particular functions or implement particular abstract data types. The order in which the method 400 is described is not intended to be construed as a limitation, and any number of the described method blocks can be combined in any order to implement the method 400. Additionally, individual blocks may be deleted from the method 400 without departing from the spirit and scope of the subject matter described herein. Furthermore, the method 700 can be implemented in any suitable hardware, software, firmware, or combination thereof.

At block 410, receiving meeting data and information about a plurality of registered participants 108. In an embodiment, a meeting organizer selects a plurality of registered participants for the meeting by providing information like name, e-mail id of the registered participants. In an embodiment, the meeting organizer may select participants based on roles of the participant. In an exemplary embodiment, the meeting organizer can be one of the participants for the meeting. In addition, the meeting organizer inputs the meeting data like type of meeting, participant's role for the meeting e.g.: mandatory or optional, list of participants for the meeting, roles of the participants, time for the proposed meeting, location of meeting, and mode of communication for the meeting etc.

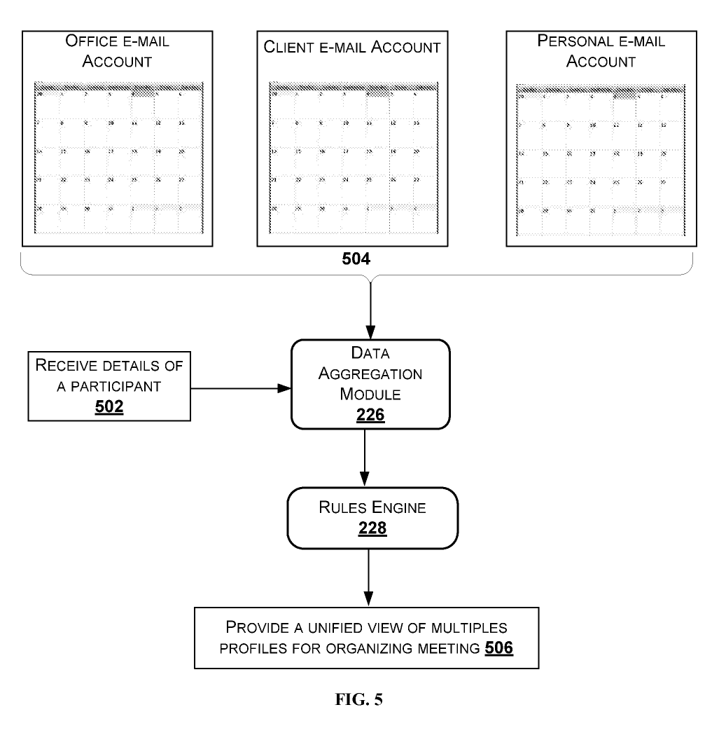

At block 420, generating a unified view of one or more profiles of each registered participant based on one or more predefined rules. FIG. 5 illustrates a flow diagram for providing a unified view of multiple profiles of a participant in accordance with some embodiments of the present disclosure

At block 502, the details of selected participants are received by the meeting scheduler module 222. The meeting scheduler module 222 extracts information of each of the participant using the data aggregation module 226. The information of the participants may include calendar information of each participant from the one or more mail servers 108 as shown at block 504. The information may also include skills and rules information from the smart meeting data 214.

Then, the rules from the rules engine 228 are extracted and applied to display the participant information.

At block 506, a unified view of multiple profiles of each participant is displayed to the meeting organizer for organizing meeting.

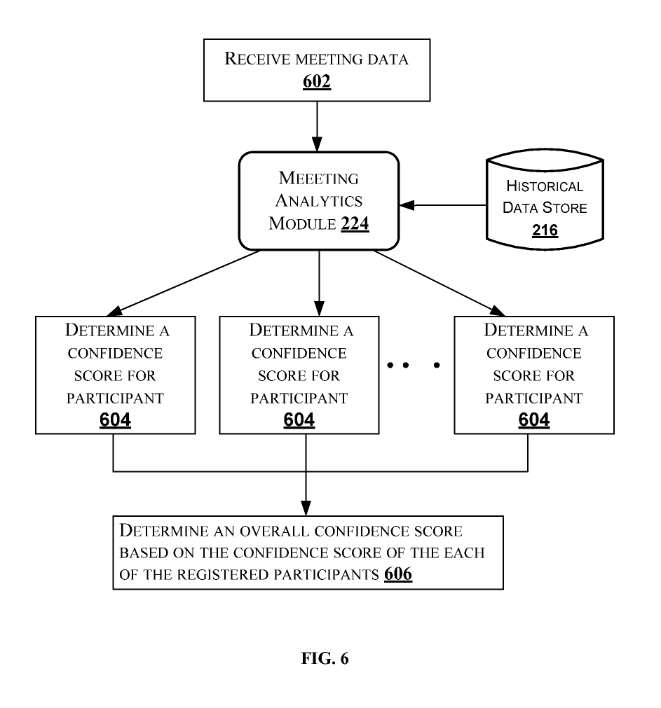

Referring back to FIG. 4, at block 430, determine a confidence score for predicting success of the meeting based on meeting data and historical data of each of the participant. FIG. 6 illustrates a flow diagram for determining a meeting confidence score in accordance with some embodiments of the present disclosure

At block 602, meeting data is received by the meeting analytics module 224. The meeting data may include type of meeting, role of the participant e.g.: mandatory or optional, list of participants for the meeting, roles of the participants, time for the proposed meeting, location of meeting, and mode of communication for the meeting etc. In addition, the meeting analytics module 224 extracts historical data of each of the participants from the historical data store 216. As an example, the historical data in the historical data store may include, history of participant for accepting meeting, history of participant for joining accepted meeting, history of active participant level of the participant, requesting for meeting cancellation or request to postpone/prepone meeting by the participant, time of meeting and availability of participant at the timeslot, time of meeting and preferred timing for meeting for the participant, e.g. participant does not prefer meetings post 8:00 pm, communication tool for the meeting and communication preferences of participant, time of meeting and location of participant, role of participant—Mandatory/Optional/Others, history of participant attending meeting for similar subject or from same organizer and history of participant attending the meeting at the time slot specified for the meeting.

At block 604, a confidence score of each of the participant for the meeting is determined. The meeting analytics module determines a confidence score for predicting success of the meeting organization based on at least one of the meeting data and historical data of each of the registered participant. In an embodiment, an initial confidence score is predefined for each of the registered participant based on the meeting data. The meeting data may include type of meeting, participant's role for the meeting e.g.: mandatory or optional, list of participants for the meeting, roles of the participants, time for the proposed meeting, location of meeting, and mode of communication for the meeting etc. Then, for each of the registered participant, the initial confidence score is modified based on the parameters of the historical data. For example, if the registered participant accepts meeting proposal, then the initial confidence score is modified by adding ‘x’ points. In the alternative, if the registered participant declines meeting proposal, then the initial confidence score is modified by subtracting ‘y’ points. Similarly, the initial confidence score may be modified by adding ‘z’ points if the registered participant is available from a specific location at scheduled time. Further, the initial confidence score may be modified based on other parameters of historical data to obtain a final confidence score for each of the registered participant. In the above examples, points ‘x’, ‘y’ and ‘z’ can be assigned any number ranging between 1 to 100, without limiting the scope of the present disclosure. Based on weightage assigned to the one or more parameters of the historical data, the value of points ‘x’, ‘y’, ‘z’ etc. may vary.

Then, at block 606, an overall confidence score for predicting success of meeting is calculated. In an embodiment, the overall confidence score is calculated based on confidence score of each of the registered participants. Also, other factors like list of participants, type of meeting, role of participants, location of meeting and time for meeting are taken into consideration for determining the overall confidence score.

Referring back to FIG. 4, at block 440, the meeting organizer modifies the meeting schedule based on the confidence score. If the confidence score is not positive, i.e. majority of participants may not attend the meeting, or important participants may not attend the meeting, then the meeting organizer may reschedule the meeting schedule or modify the meeting schedule.

At block 450, transmit meeting invitation to a participant device 102 associated to each of the registered participants. If the confidence score is positive, then the meeting organizer transmits meeting invitation to the selected registered participants on the participant device 102.

In an embodiment, once the meeting is completed, the meeting organizer may update the details of the meeting in the historical data 216 for future reference. The details of meeting which is updated by the meeting organizer, includes, for example, participants who attended the meeting, participation level of each participant, like active or inactive etc.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor or a processor capable of processing and executing the queries. The processor may be implemented as a central processing unit (CPU) for test automation system 112. The CPU may include one or more processing units having one or more processor cores or having any number of processors having any number of processor cores. CPU may include any type of processing unit, such as, for example, a multi-processing unit, a reduced instruction set computer (RISC), a processor having a pipeline, a complex instruction set computer (CISC), digital signal processor (DSP), and so forth. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all of the items are mutually exclusive, unless expressly specified otherwise. Moreover, the terms “first,” “second,” “third,” and so forth, are used merely as labels, and are not intended to impose numerical requirements on their objects.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3 and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processor or by distributed processing units.

Additionally, advantages of present disclosure are illustrated herein.

In an embodiment, the present disclosure provides a method to predict availability of participants.

In an embodiment of the present disclosure, the method a unified view of multiple profiles of user.

In an embodiment, the method of the present disclosure predicts probability of each participant attending the meeting.

Finally, the language used in the specification has been principally selected for readability and instructional purposes, and it may not have been selected to delineate or circumscribe the inventive subject matter.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of scheduling meetings comprising:
receiving, by a meeting organizer computing device, meeting data and information related to a plurality of registered participants;
generating, by the meeting organizer computing device, a unified view of one or more profiles of each of the registered participants based on one or more predefined rules;
determining, by the meeting organizer computing device, a confidence score for predicting a success of a meeting organization based on at least one of the meeting data or historical data of each of the registered participants;
modifying, by the meeting organizer computing device, a meeting schedule based on the confidence score; and
transmitting, by the meeting organizer computing device, a meeting invitation to a participant device associated with each of the registered participants based on the confidence score.

2. The method as claimed in claim 1 further comprising:
updating, by the meeting organizer computing device, the historical data with a status of a meeting after the meeting is completed.

3. The method as claimed in claim 2, wherein the status of the meeting comprises information of one or more of the plurality of registered participants who attended the meeting, a reason for declining the meeting by the one or more registered participants, or a participation level of each of the registered participants.

4. The method as claimed in claim 1, wherein determining the confidence score for predicting success of the meeting comprises:
determining, by the meeting organizer computing device, a confidence score for each of the plurality of registered participants; and
determining, by the meeting organizer computing device, an overall confidence score based on the determined confidence score for each of the plurality of registered participants, a type of meeting for the each of the registered participants, a role of each of the registered participants, a location of the meeting, and a time of the meeting.

5. The method as claimed in claim 1 further comprising:
identifying, by the meeting organizer computing device, information from one or more profiles of one of the plurality of registered participants;
determining, by the meeting organizer computing device, rules for the participant from the one or more profiles; and
mapping, by the meeting organizer computing device, skills received from the one or more profiles to the participant.

6. The method as claimed in claim 1 further comprising:
validating, by the meeting organizer computing device, the one or more profiles of the registered participants based on data of the corresponding registered participant from one or more external systems.

7. The method as claimed in claim 1, wherein the meeting organizer selects the plurality of registered participants based on roles of the plurality of the registered participants.

8. A meeting organizer computing device, comprising:
a processor coupled to a memory and configured to execute programmed instructions stored in the memory, comprising:
receiving meeting data and information related to a plurality of registered participants;
generating a unified view of one or more profiles of each of the registered participants based on one or more predefined rules;
determining a confidence score for predicting a success of a meeting organization based on at least one of the meeting data or historical data of each of the registered participants;
modifying a meeting schedule based on the confidence score; and
transmitting a meeting invitation to a participant device associated with each of the registered participants based on the confidence score.

9. The device as claimed in claim 8, wherein the processor is further configured to execute programmed instructions stored in the memory further comprising:
updating the historical data with a status of a meeting after the meeting is completed.

10. The device as claimed in claim 8, wherein the status of the meeting comprises information of one or more of the plurality of registered participants who attended the meeting, a reason for declining the meeting by the one or more registered participants, or a participation level of each of the registered participants.

11. The device as claimed in claim 8, wherein determining the confidence score for predicting success of the meeting comprises:
determining a confidence score for each of the plurality of registered participants; and
determining an overall confidence score based on the determined confidence score for each of the plurality of registered participants, a type of meeting for the each of the registered participants, a role of each of the registered participants, a location of the meeting, and a time of the meeting.

12. The device as claimed in claim 8, wherein the processor is further configured to execute programmed instructions stored in the memory further comprising:
identifying information from one or more profiles of one of the plurality of registered participants;
determining rules for the participant from the one or more profiles; and
mapping skills received from the one or more profiles to the participant.

13. The device as claimed in claim 8, wherein the processor is further configured to execute programmed instructions stored in the memory further comprising:
validating the one or more profiles of the registered participants based on data of the corresponding registered participant from one or more external systems.

14. The device as claimed in claim 1, wherein the meeting organizer selects the plurality of registered participants based on roles of the plurality of the registered participants.

15. A non-transitory computer readable medium having stored thereon instructions for scheduling meetings comprising machine executable code which when executed by a processor, causes the processor to perform steps comprising:
receiving meeting data and information related to a plurality of registered participants;
generating a unified view of one or more profiles of each of the registered participants based on one or more predefined rules;
determining a confidence score for predicting a success of a meeting organization based on at least one of the meeting data or historical data of each of the registered participants;
modifying a meeting schedule based on the confidence score; and
transmitting a meeting invitation to a participant device associated with each of the registered participants based on the confidence score.

16. The medium as claimed in claim 15 further comprising machine executable code which when executed by the processor, causes the processor to perform steps further comprising:
updating the historical data with a status of a meeting after the meeting is completed.

17. The medium as claimed in claimed 15, wherein the status of the meeting comprises information of one or more of the plurality of registered participants who attended the meeting, a reason for declining the meeting by the one or more registered participants, or a participation level of each of the registered participants.

18. The medium as claimed in claim 15 wherein determining the confidence score for predicting success of the meeting comprises:
determining a confidence score for each of the plurality of registered participants; and
determining an overall confidence score based on the determined confidence score for each of the plurality of registered participants, a type of meeting for the each of the registered participants, a role of each of the registered participants, a location of the meeting, and a time of the meeting.

19. The medium as claimed in claim 15 further comprising machine executable code which when executed by the processor, causes the processor to perform steps further comprising:
identifying information from one or more profiles of one of the plurality of registered participants;
determining rules for the participant from the one or more profiles; and
mapping skills received from the one or more profiles to the participant.

20. The medium as claimed in claim 15 further comprising machine executable code which when executed by the processor, causes the processor to perform steps further comprising:
validating the one or more profiles of the registered participants based on data of the corresponding registered participant from one or more external systems.
